(19) United States
(12) Patent Application Publication
(10) Pub. No.: US 2016/0289994 A1
(43) Pub. Date: Oct. 6, 2016

(54) Retractable flagpole

(71) Applicant: Ryan Schilling, Kettering, OH (US)

(72) Inventor: Ryan Schilling, Kettering, OH (US)

(21) Appl. No.: 14/952,398

(22) Filed: Nov. 25, 2015

Related U.S. Application Data
(60) Provisional application No. 62/143,003, filed on Apr. 3, 2015.

(51) Int. Cl. E04H 12/32; H02P 29/20; G09F 17/00

(52) U.S. Cl. CPC E04H 12/32; G09F 17/00; H02P 29/20

(57) ABSTRACT

A flagpole retracts a flag for storage and mounts on the side of a building or other vertical surface. Internally, the flagpole proves a tension released roller and cords to retract the flag into the flagpole, and roll up the flag around the roller. The roller is released by pressing a button at the base of the flagpole, within easy reach of the user.

### CROSS-REFERENCE TO RELATED APPLICATIONS

This Application claims the benefit of U.S. Provisional Application No. 62/143,003, filed Apr. 3, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable REFERENCE TO SEQUENCE LISTING, A TABLE, OR A COMPUTER PROGRAM

### LISTING COMPACT DISK APPENDIX

Not Applicable

### BACKGROUND OF THE INVENTION

The invention relates generally to flags and accessories, and in particular to a retractable flagpole. Federal law requires United States flags to be lowered upon the arrival of inclement weather. A mechanism which would make the process quick, easy, and reliable for ordinary homeowners would be well-received. A retractable flagpole, which provides a mechanism to retract and roll up the flag inside the flagpole, would resolve this problem.

### SUMMARY OF THE INVENTION

Accordingly, the invention is directed to a retractable flagpole. The flagpole is intended for mounting on the side of a building or some other vertical surface. Internally, the flagpole proves a tension released roller and cords to retract the flag into the flagpole, and roll up the flag around the roller. The roller is released by pressing a button at the base of the flagpole, within easy reach of the user.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a side transparency view of the first exemplary embodiment, displaying the flagpole 10, the roller 11, the flag 12, and the button 13.

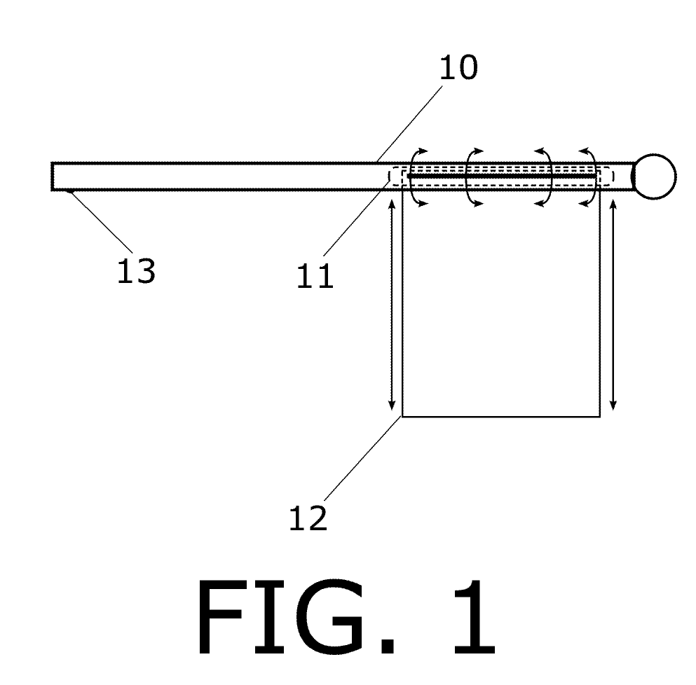

FIG. 2 shows a side cutaway view of the roller of the first exemplary embodiment, displaying the roller 11, the flag 12, the cylindrical pin 14, the spring 15, the pawl 16, the flat pin 17, and the ratchet 18.

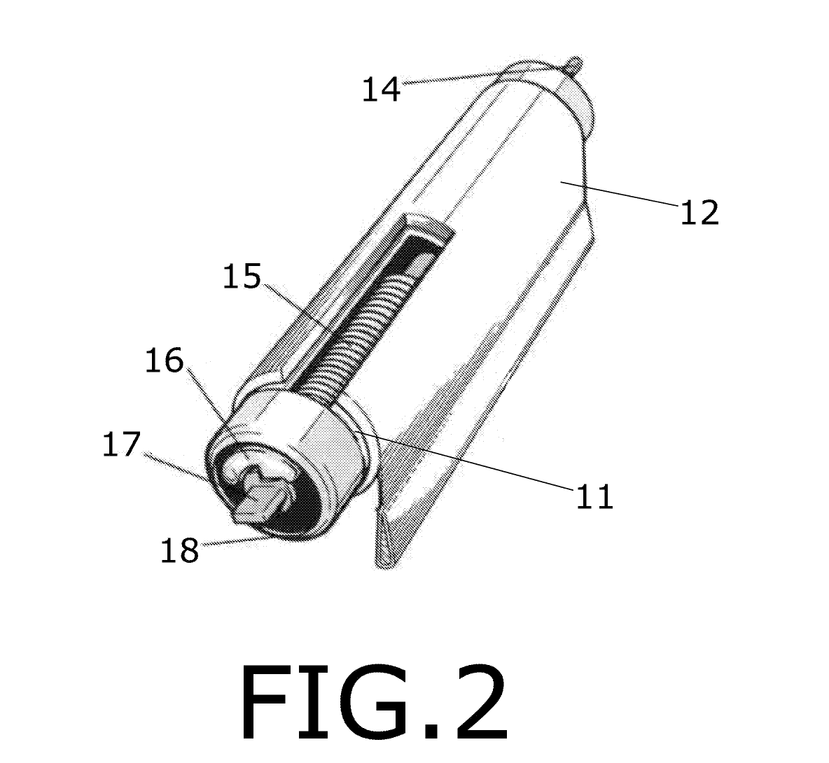

FIG. 3 shows a side transparency view of the second exemplary embodiment with the flag retracted, displaying the flagpole 10, the aperture 10A, the roller 11, the flag 12, and the servomotor 19.

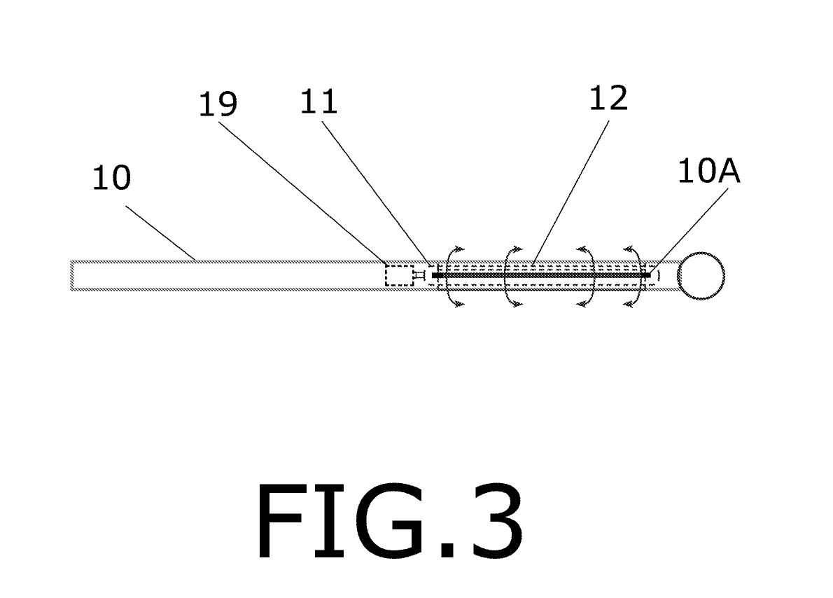

### DETAILED DESCRIPTION OF THE INVENTION

Referring now to the invention in more detail, the invention is directed to a retractable flagpole 10.

The first exemplary embodiment is comprised of a hollow flagpole 10, which is intended for mounting on the side of a building or some other vertical surface. The flagpole 10 preferably provides a swivel on the base. Internally, the flagpole 10 proves a tension released roller 11 to retract the flag 12 into the flagpole 10 through a slit-shaped aperture 10A, and roll up the flag 12 around the roller 11. The mechanism is similar to that found on a roller shade for a window, with a spring 15 and ratchet 18 provided on the roller 11. The roller 11 is released by pressing a button 13 at the base of the flagpole 10, within easy reach of the user.

The roller 11 provides a cylindrical pin 14 at the upper end and a ratchet 18, a spring 15, a pawl 16, and a flat pin 17 at the lower end. The cylindrical pin 14 allows the roller 11 to turn easily, while the flat pin 17 prevents the spring 15 from turning when the roller 11 is turned, creating the tension necessary to retract the flag 12. When the flag 12 is extended, the pawl 16 and ratchet 18 stop the movement of the flag 12 when the flag 12 is released.

An alternate embodiment, wherein the flagpole 10 may be operated by remote control, is contemplated. A battery-powered remote control device, which preferably operates a radio frequency (RF) transmitter, controls a battery-powered servomotor 19 in the flagpole 10 to turn the roller 11 and retract the flag 12.

To use the first or the second exemplary embodiment, the user pulls the edge of the flag 12 gently to extend the flag 12 out of the flagpole 10. The spring 15 within the roller 11 prevents the flag 12 from overextending. For the first exemplary embodiment, to retract the flag 12, the user presses the button 13 at the base of the flagpole 10, which releases the ratchet 18 and causes the flag 12 to retract within the flagpole 10. For the second exemplary embodiment, to retract the flag 12, the user operates the remote control to activate the servomotor 19, which turns the roller 11 and retracts the flag 12.

The flagpole 10, the cylindrical pin 14, the pawl 16, the flat pin 17, and the ratchet 18 are preferably manufactured from a rigid, durable material with substantial structural strength, such as steel or aluminum alloy. The roller 11 is preferably manufactured from a rigid, durable material which is lightweight, such as wood. The flag 12 is preferably manufactured from a flexible, durable fabric, such as cotton or a cotton-rayon blend. The button 13 is preferably manufactured from a rigid, durable material such as wood, plastic, steel, or aluminum alloy. The spring 15 is preferably manufactured from a semi-rigid, durable material such as spring steel. The cords are preferably manufactured from a flexible, durable fiber such as cotton or nylon.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A retractable flagpole comprising:
(a) a flagpole having an upper half;
(b) a roller;
(c) said roller being located in said upper half of said flagpole;
(d) an external, longitudinal aperture being coterminous with said roller;
(e) sidewinder cords being mounted on reels at the ends of said roller;
(f) a flag having one end being affixed to said roller and emerging from said aperture.

2. The retractable flagpole of claim 1 further comprising a swivel on the lower end of said flagpole.

3. The retractable flagpole of claim 1, wherein said roller is a tension release roller and is located within said upper half of said flagpole.

4. The retractable flagpole of claim 3, further comprising a ratchet and spring being mounted within said roller; said ratchet and spring being shaped, positioned, and operating to correspond with one another and with said roller; said ratchet and spring being shaped, positioned, and operating to create tension and release said tension to roll said flag around said roller; said flag being positioned such that it may be manually pulled out of said aperture and extended; said ratchet and spring being shaped, positioned, and operating to prevent said flag from being overextended; a button being mounted on the lower end of said flagpole; and said button operating to release said tension in said ratchet and spring, causing said flag to be retracted and rolled up on said roller.

5. The retractable flagpole of claim 1 further comprising:
(a) a battery-powered remote control device;
(b) a battery-powered servomotor mounted within said flagpole;
(c) said servomotor operating to cause said flag to be retracted and rolled up or deployed and rolled out on said roller when activated;
(d) said remote control device operating to control said servomotor when activated.

6. The retractable flagpole of claim 5 further comprising a radio frequency transmitter mounted within said remote control device for communication with said servomotor and configured to activate said servomotor.
